(19) United States
(12) Patent Application Publication
(10) Pub. No.: US 2011/0121726 A1
(43) Pub. Date: May 26, 2011

(54) SOLID-STATE LAMP

(75) Inventors: Alexei A. Erchak, Cambridge, MA (US); Michael Denninger, Bedford, MA (US); Dirk Fieberg, Billerica, MA (US); David Doyle, San Francisco, CA (US)

(73) Assignee: Luminus Devices, Inc., Billerica, MA (US)

(21) Appl. No.: 12/831,948

(22) Filed: Jul. 7, 2010

Related U.S. Application Data
(60) Provisional application No. 61/263,590, filed on Nov. 23, 2009.
(60) Provisional application No. 61/264,435, filed on Nov. 25, 2009.

(51) Int. Cl. H01K 1/62

(52) U.S. Cl. 315/32

(57) ABSTRACT

A solid-state lamp using a light-emitting diode (LED) as a light source is described. In some embodiments, a segmented driver allows for greater flexibility with the optical and thermal design of the solid-state lamp.

### RELATED APPLICATIONS

This application claims priority to U.S. Provisional Application No. 61/263,590 filed Nov. 23, 2009 and U.S. Provisional Application No. 61/264,435 filed Nov. 25, 2009, both of which are incorporated herein by reference.

### BACKGROUND OF INVENTION

1. Field of Invention

The present embodiments relate generally to light-emitting devices, and particularly to light-emitting devices using a light-emitting diode (LED) as the light source.

2. Description of the Prior Art

A light-emitting diode (LED) can often provide light in a more efficient manner than an incandescent light source and/or a fluorescent light source. The relatively high power efficiency associated with LEDs has created an interest in using LEDs to displace conventional light sources in a variety of lighting applications. For example, in some instances LEDs are being used as traffic lights, to illuminate displays systems and so forth. Furthermore, LEDs are being incorporated into residential and commercial lighting applications displacing less efficient and less durable light devices. Many technological advances have led to the development of high power LEDs by increasing the amount of light emission from such devices.

As LEDs have increasingly become desirable for their long lifespan, efficient energy consumption and durability, a need to configure LED lighting devices to fit and function similar to traditional lighting sources has arisen.

### SUMMARY OF INVENTION

Solid-state lamp devices are provided.

In one aspect, a device is provided comprising a base having a first and second electrical terminal, a driver, an LED electrically connected to the driver, a housing mounted to the base, wherein the housing is in thermal communication with the LED and a portion of the driver device.

In another aspect, a device is provided comprising a base having a first and second electrical terminal, a driver having at least two portions, wherein one portion is partially disposed within the base and the second portion produces a greater amount of heat, an LED electrically connected to the driver device, a housing mounted to the base, wherein the housing is in thermal communication with both the LED and second portion of the driver.

In another aspect, a driver device is provided having a first portion for receiving an alternating current, and a second portion thermally isolated from the first portion, wherein the second portion outputs more heat than the first portion; an LED electrically connected to the driver device; and a heat sink thermally connected to the second portion.

Other aspects, embodiments, and features will become evident from the detailed description and the accompanying figures. The accompanying figures are schematic and are not intended to be drawn to scale. In the figures, each identical or substantially similar component that is illustrated in various figures is represented by a single numeral or notation.

For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

FIG. 1 is prior art of a light device having a filament source.

FIG. 2 is prior art of a light device having multiple LED sources.

FIG. 3 is prior art of another light device having multiple LED sources.

FIGS. 4a-b are electrical schematics representative of a segmented driver device attached to an LED source.

FIG. 5 is representative of a segmented driver device having electrical leads between each driver portion.

FIG. 6 is representative of a secondary driver portion surrounding an LED mounted to a pedestal.

FIGS. 7a-b illustrate various placements of driver devices in a solid-state lamp assembly.

FIG. 8 illustrates a partial cross-sectional view of a solid-state lamp having an air channel.

FIG. 9 is an illustrative view of a lamp housing having a multiplicity of heat fins having an arching profile.

FIGS. 10a-b are exploded views of an MR-16 solid-state lamp.

FIGS. 11a-e are illustrative of cross-sectional views of the internal designs used in various solid-state lamp embodiments

FIG. 12 is illustrative of a reflective optic used to direct light inside a solid-state lamp.

FIG. 13 is illustrative of a surface-emitting LED that may be placed in a solid-state lamp.

### DETAILED DESCRIPTION

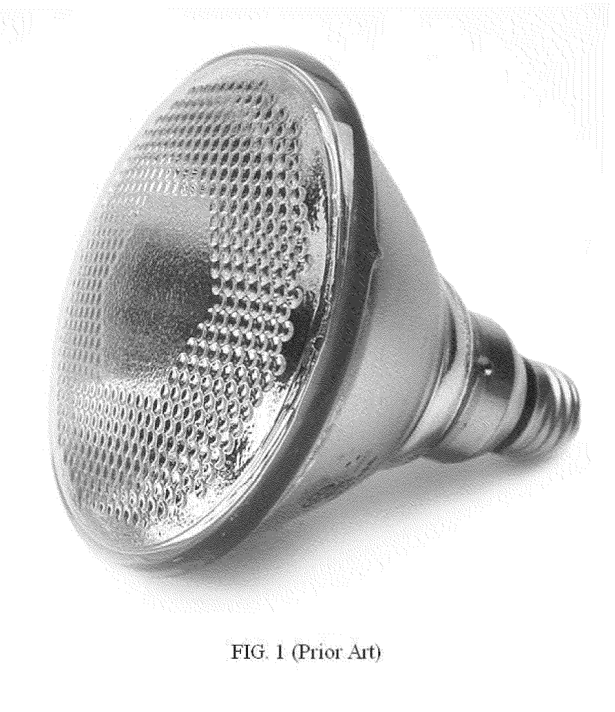

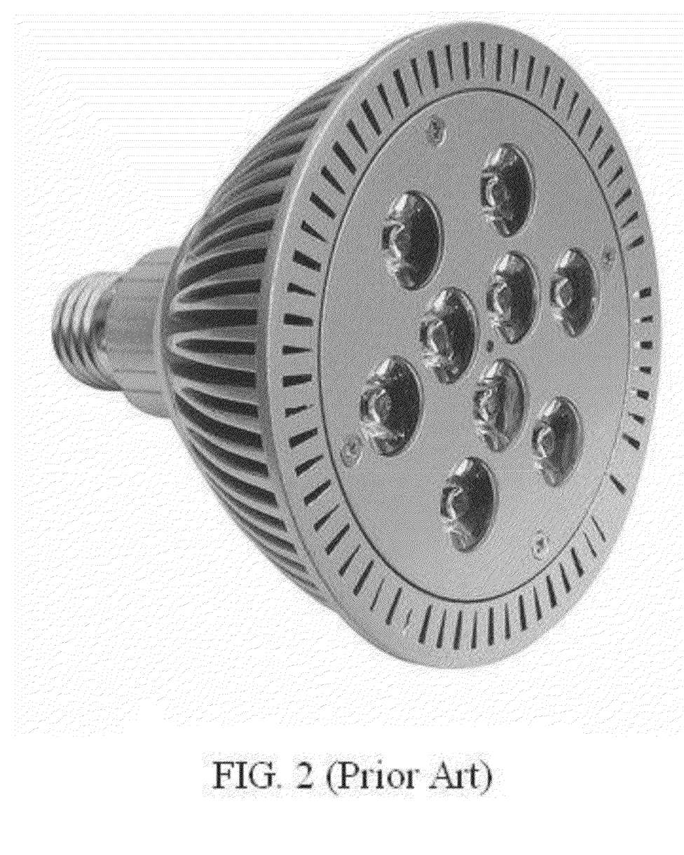

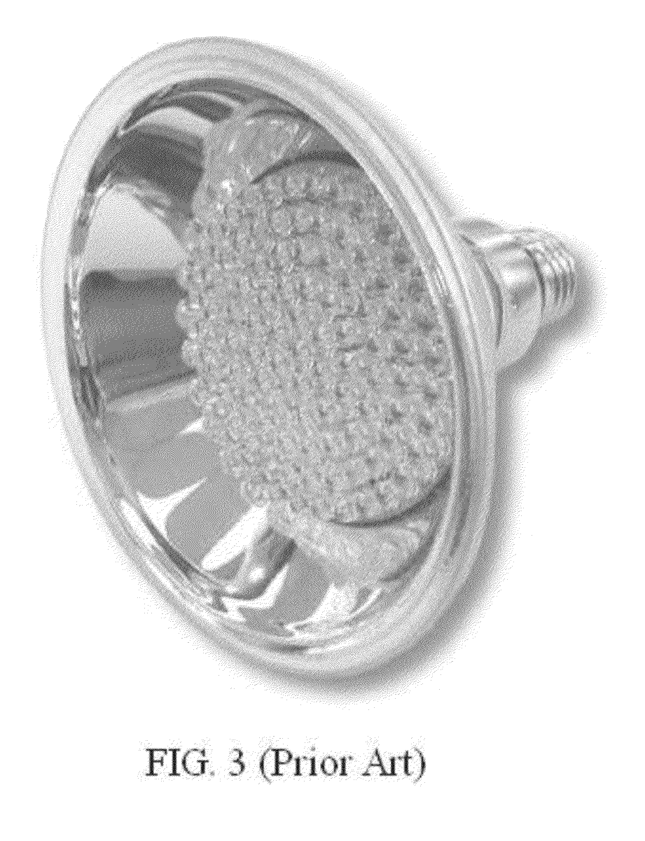

LEDs have become increasingly desirable to replace traditional filament based lighting sources because of their durability, longer lifespan, and increased electrical efficiency. Filament based lighting sources have been the standard in industry for several decades and as a result have an infrastructure designed around such a lighting solution such as one shown in FIG. 1. As LEDs have become increasingly desirable to replace traditional LEDs, several designs have arisen such as those shown in FIGS. 2-3 to replace the lighting source in FIG. 1. However, each of these sources contains several smaller LED sources, which create several point sources. This multiplicity of point sources, because of general optical properties, creates a solution that does not create emission patterns similar to that of the traditional filament based lighting solution.

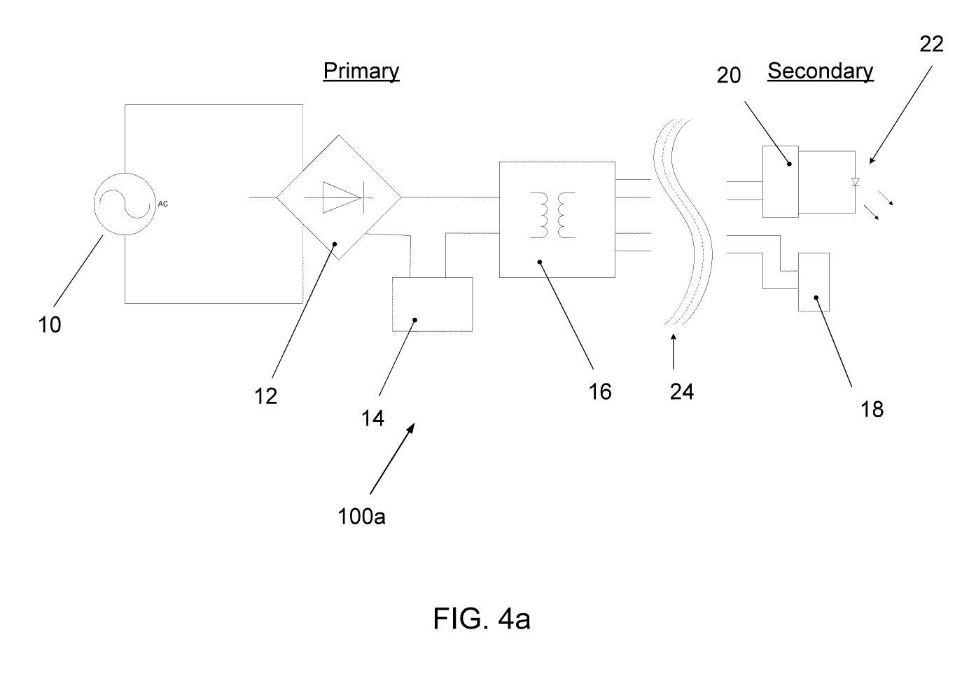

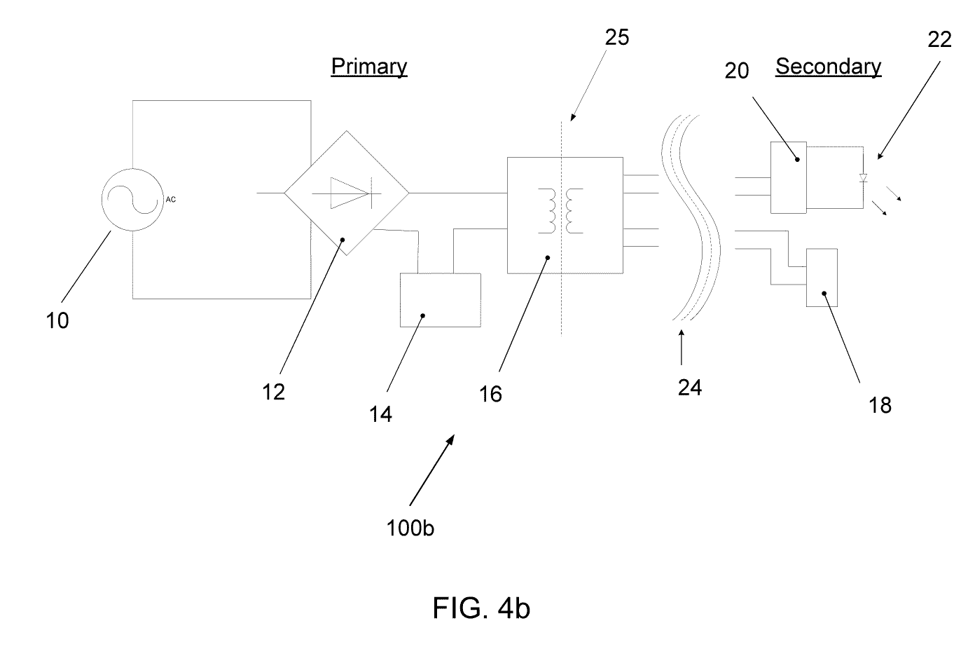

FIGS. 4a-b are electrical schematics representative of a segmented driver device attached to an LED source. FIG. 4a shows a thermal separation 24 between the primary and secondary portions of an electronic driver 100a. One advantage of a segmented electronic driver, such as 100a, is that the portion of the driver that exhibits the greatest amount of heat output may be more strategically placed along optimal thermal paths. Such a flexibility to position various segmented portions such as the primary and secondary portions shown in FIG. 4a become more relevant in smaller solid-state lamp packages.

In the embodiment shown in FIG. 4a an AC input 10 delivers power into the electronic driver 100a of the primary portion. A bridge rectifier converts the alternating current received from input 10 into a direct current. A primary side controller 14 used for regulating power conversion of the electrical input may or may not include a power factor correction. A transformer 16 is also present on the primary portion to adjust the voltage leading into the secondary portion of the electronic driver 100a. Though it is contemplated that some embodiments of an electronic device driver may not include a transformer, it is nevertheless shown in the current embodiments as present.

Generally, the current on the primary portion of the electronic driver 100a is much lower than the current on the secondary portion. The higher current often results in an increased output of heat across that portion of the electronic driver. One reason an increased amount of current is desired is because in some embodiments, a larger surface-emitting or vertical chip LED is used. In order to maintain the same current density as used by smaller LEDs, the driver must produce higher current entering into the larger LED used in many of the embodiments described. As such, the secondary portion of the driver will produce more heat as it produces more current to maintain this current density. Additionally, more light will be produced as a result.

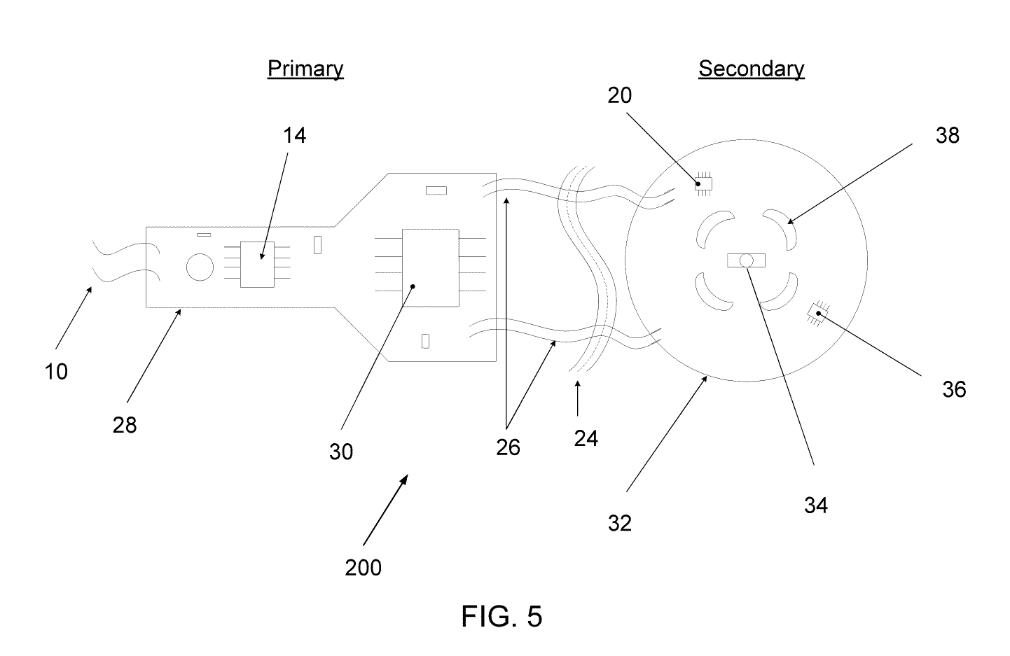

The secondary portion receives the electrical input from the primary portion via electrical leads (such as 26 shown in FIG. 5) and further regulates the input through a secondary synchronous regulator 20 that controls the current to LED(s) 22 as well as reduces ripple in the system. A feedback control circuitry 18 in addition monitors the system and can provide valuable information to the primary controller such as LED temperature, LED voltage, LED current and other information about actual color temperature, etc.

Suitable LEDs have been described in commonly-owned U.S. Pat. No. 6,831,302 which is incorporated herein by reference. In some embodiments, the LED may have a vertical design (i.e., emit light vertically from an upper surface) and/or large emission area. For example, the emission surface may have at least one edge (and, in some cases, all edges) having a length of at least 1 mm, at least 2 mm, at least 3 mm, at least 4 mm, or at least 5 mm.

In some embodiments, the lighting source (e.g., lamp) includes a single LED chip. In other cases, the lighting source may include more than one LED chip (e.g., a multi-chip configuration).

In some embodiments, the LED(s) emit white light. In some embodiments the electricity to light output efficacy is greater than 82%. Combining a single LED emitting white light at a desired color temperature, with the segmented driver devices described herein, while managing the heat output as discussed below allows for the solid-state lamp to be more efficient, last longer while maintaining a high percentage of initial lumen output, easier to maintain, and operate in the same sockets over traditional filament-based lamps.

In certain embodiments, the solid-state lamp may have a power factor that is greater than or equal to 0.70 and in most embodiments from 0.88 to 0.90. The output frequency may also be greater than or equal to 120 Hz. In addition, in some embodiments when the solid-state lamp is connected to a power source and in the off state no power is drawn from the power system or grid.

FIG. 4b is an electronic schematic of an electronic driver 100b having a primary portion being separate by both a thermal separation 24 and an electrical separation 25 from the secondary portion. As shown in FIG. 4b the thermal and electrical separations reside in distinct locations; however, the thermal and electrical separations in other embodiments may be in physically overlapping locations. In other embodiments the segmented electronic driver may have more than two portions.

FIG. 5 is representative of a segmented electronic driver device 200 attached to a single LED 34. In this particular embodiment the primary portion 28 may be made of a printed circuit board (PCB) that is used to mechanically support the electronic driver components including AC input 10, primary side controller 14, transformer 30 and conductive leads 26 that electrically connect the primary portion to the secondary portion. The printed circuit board may be made of a variety of materials including FR-4 and other standard materials used in the industry.

The primary portion 28 in the embodiment shown in FIG. 5 does not produce high amounts of heat as compared to the secondary portion 32. This lower output of heat coupled with the thermal separation 24 allows for the primary portion 28 to be made of PCB materials such as FR-4 that generally have a higher thermal resistance values. Oftentimes, components made of FR-4 are easier and less expensive to manufacture. In addition, the lower heat output from the primary portion 28 of electronic driver device 200 allows 28 to be strategically placed in an area of a lamp configuration that may not require higher heat capacity distribution channels. This may include the base portion of an MR or PAR lamp design, where the base portion may have less exposure to heat distribution channels such as heat sinks, fins and free flowing air channels. One type of base design, configured to place at least a portion of the primary portion 28 into, may include a lamp having a receptacle configured for an Edison-style socket.

The spatial layout of the electronic driver 200, for example in a PAR lamp configuration, is important due to the need to maintain the same form and fit of traditional lamp designs. In some embodiments, it is desirable to position the driver such that it is separated from the heat sink that sits directly underneath the LED. The separation may be for purposes of electrical isolation. However, it may also be desirable to separate the driver for more efficient cooling of the system. In other embodiments, it may be for purposes of miniaturization of the entire lamp sub-system. In most LED lamp designs, the driver is positioned underneath or in close-proximity to the LED. In some embodiments, it may be desirable to position the driver in alternative locations for miniaturization or heat-sinking purposes.

The secondary portion 32 of the electronic driver device 200 generally produces greater amounts of heat. Therefore, it is advantageous to use a metal core printed circuit board (MCPCB) or similarly configured circuit board designed to effectively distribute heat away from both the secondary portion 32 as well as LED 34 mounted directly to the inner area of the secondary portion 32. As mentioned, LED 34 may have a large surface-emitting area greater than 1 mm², 3 mm², 9 mm² and 12 mm², which may produce upwards of 10 watts of heat depending upon how much current is being driven through LED 34.

Included in the secondary portion 32 of the embodiment shown in FIG. 5 are thermal islands 38. These thermal islands are designed to prevent additional heat from spreading out onto the rest of the secondary portion supporting other electrical components such as the feedback control circuitry 36 and the secondary regulator 20. These islands may be comprised of vacant cavities in the MCPCB or they may be comprised of another heat resistive material. Thermal islands 38, as shown surrounding LED 34, are placed in a concentric manner. However, it is conceived that a variety of shapes may be used to partially surround LED 34 in order to adequately prevent heat output from LED 34 from negatively effecting or damaging other electrical components contained on or within the secondary driver portion 32. It is also contemplated in some embodiments that thermal islands 38 may be unnecessary where the heat output of LED 34 is low enough to not have a negative thermal effect on the secondary driver portion 32.

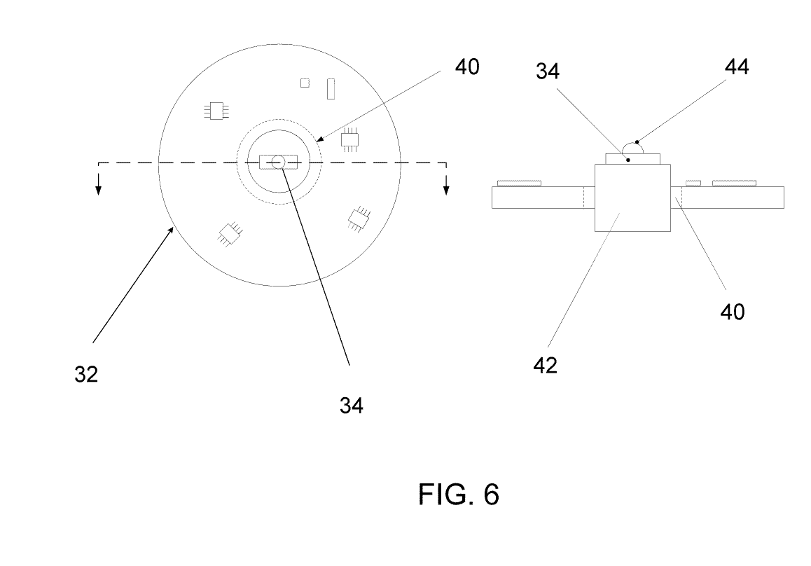

FIG. 6 is representative of a secondary portion 32 of an electronic driver, where the secondary portion 32 surrounds LED 34 mounted to pedestal 42, whereby a thermal isolation path 40 thermally isolates pedestal 42 from the rest of the secondary portion 32. As shown in the cross-section view, the pedestal 42 raises LED 34 above the circular shaped secondary portion. Pedestal 42 may be advantageous for several reasons including providing a proper optical distancing for LED 34 with respect to the housing of a lamp to achieve the desired optical output. The pedestal 42 also acts as a thermal heat sink drawing heat from LED 34 and disbursing it away from the LED 34 in a manner that has minimal effect on the secondary portion 32. This pedestal may be made of copper, aluminum, or other thermally conductive materials known to channel and disperse heat away including combinations of materials.

Though not shown in the embodiment found in FIG. 6, the secondary portion 32 may also partially enclose an area surrounding an LED.

Attached to LED 34 is an optical dome 44. Optical dome 44 may be used in shaping the output of light emitted from LED 34. This optical dome 44 may also be coated or otherwise implanted with a phosphor or other color converting mechanism to help create a different monochromatic or polychromatic emission than the original emission produced from LED 34.

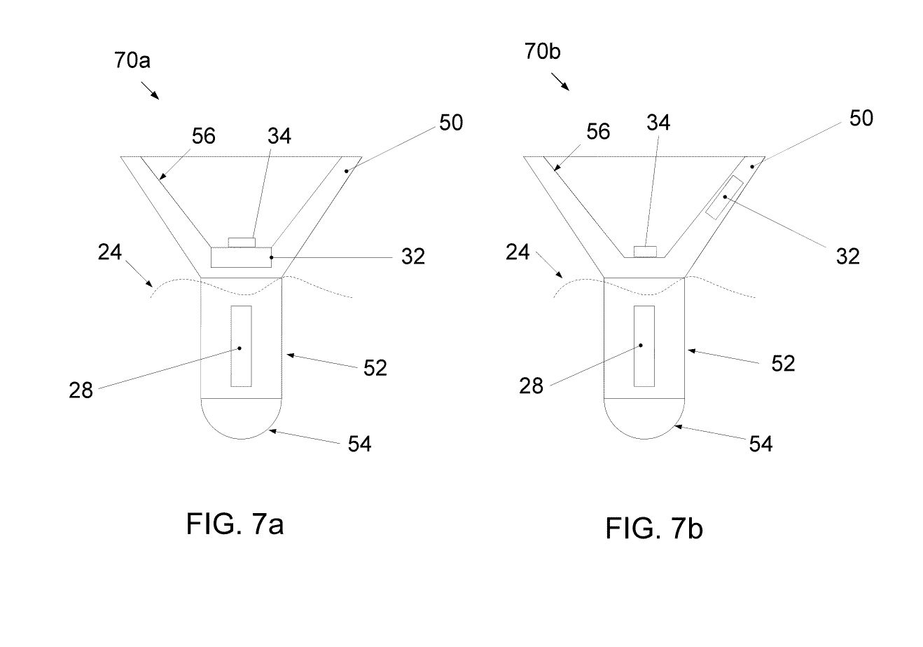

FIGS. 7a-b show various placements segmented electronic driver devices may be placed within a solid-state lamp assembly. FIGS. 7a-b are not drawn to proportion, but are meant to be illustrative section views of the various embodiments. As described above, having a segmented electronic driver allows for greater flexibility within a lamp design; particularly, when constraints of form, fit and functionality of prior incandescent sources are desired. This flexibility allows for integrating a solid-state lighting system comprised of an electronic driver and an LED to be incorporated into a lamp package design to replace traditional incandescent sources.

FIG. 7a illustrates an embodiment where the primary portion 28 of an electronic driver is placed within base 52 of the lamp 70a. As shown, a thermal separation 24 exists between 28 and the secondary portion 32. This thermal separation may consist of an air gap, insulation or other means configured to place the portion of the driver with the highest output of heat in an area of the lamp configured to handle heat dissipation in an efficient manner. The portion of the driver that does not have a high output of heat may then be strategically located in an area of the lamp that is not needed for optical, thermal or other uses. At times this may be the base portion of the lamp.

LED 34 is mounted on top of the secondary portion 32 in the bottom portion of the cavity produced by housing 50 and above the base portion. In some embodiments the base portion may be too small to house the entire primary portion 28 and a part of 28 may protrude into the rest of the housing 50. The base of the lamp is considered to be the proximal end of the lamp while the portion of the housing where the light escapes or that is furthest away from the base is the distal end of the lamp.

Housing 50 may act as both a heat sink and a reflector for light emitted by LED 34. A portion of the inner surface 56 of the housing 50 may be coated, polished, or otherwise plated to reflect light emitted from LED 34. Housing 50 may be made of aluminum or other thermally conductive material as housing 50 as acts as part of a heat distribution and dissipation system for the lamp. Though not shown in this embodiment, housing 50 may also be comprised of protruding heat fins designed to transfer heat.

FIG. 7b shows another embodiment wherein the secondary portion 32 is placed within the extruded portion of housing 50. Placing the secondary portion 32 in this region of the housing may be advantageous because of the close proximity to an outer area of the embodiment where a majority of the cooling and heat dissipation occurs. In addition, it is located away from the LED 34 another major heat source. Though not specifically shown in this embodiment, a cavity or slot may be formed in the outer extruded portion of the housing to contain the secondary portion 32 therein. In some instances, the secondary portion 32 may be comprised of a flexible circuit, so as to conform to the shape of the housing 50. In most retrofit lamp designs used for replacing incandescent lamps, the housing maintains a constant curvature. Thus, having a flexible secondary portion would be ideal in these situations particularly where wall thickness may be of concern, as flexible circuits tend to be thinner than regular printed circuit boards.

In both FIGS. 7a-b a receiver 54 having two electrical terminals configured to fit into an Edison-style socket is connected to the base portion 52. As shown in FIGS. 7 a-b the receiver 54 is an extension of the base 52 of the lamp. In some embodiments the receiver and base are considered to be one in the same where the base is the portion of the lamp that houses at least a portion of the driver, contains electrical connections for a socket, and is the foundation portion of the lamp. Additionally, the receiver portion of the base may have a diameter smaller than main portion of the base. As shown in FIGS. 7 a-b the receiver and the base are shown to have the same width for simplicity; however, this is not always the case and often the base portion will have varying widths and diameters.

The base usually ends where the housing portion begins. Often the LED(s) are mounted on the top portion of the base. Sometimes an LED is mounted to the secondary portion of a driver or a pedestal that is connected to the base portion. However, as shown in FIGS. 7a-b the LED and secondary portion may be mounted to the lower portion of housing 50 or the portion that is attached to the base 52.

The housing usually starts at the point where the LED is mounted and usually flares noticeably outward from the base portion. Though in some embodiments the housing and the base are comprised of one continuous piece the distinction may be less significant, but principally the housing begins at the flaring out point which may be a dramatic angle, parabolic curve or otherwise. For additional clarity, the housing usually contains the optical portion of the lamp, heat fins, and generally extends outwardly from the base having a much larger diameter or width than the base. It is also conceived that a portion of the base extends into the housing portion or that the housing mounts to a ridge of the base. See for example FIGS. 10a-b.

Though not shown in FIGS. 7a-b, Dielectric materials or air gaps may be used to electrically isolate the secondary portion from the housing in certain embodiments. For instance, in FIG. 7a the secondary driver portion in the lower portion of housing 50 may be isolated in such a manner, as well as the secondary driver portion placed in the outer extruded wall portion of housing 50 shown in FIG. 7b. In some cases a non-isolated design is desirable in order to achieve greater electrical efficiency in the system although great care must be taken in the mechanical implementation of such a design in order to comply with all safety standards.

Optical coverings, not shown in FIGS. 7a-b, may be placed over the opening in housing 50 to help direct the beam angle of the emitted light from the lamp and may be used in conjunction with other optical devices such as the optical dome 44 in FIG. 6. In some embodiments the cavity formed in housing 50 may be filled with material to create a total internal reflection (TIR) optic, which may eliminate the need to coat or cause to be made reflective the inner surface of housing 50.

As mentioned, some of the embodiments presented are designed to replace current filament based lighting devices commonly referred to as PAR-XX with the XX being a dimension of the diameter of the housing at its widest point. The XX number is usually multiplied by ⅛″ to give the opening size of the lighting device. PAR is an acronym for parabolic aluminized reflector. Thus, several of the embodiments of this invention are directed towards configuring equivalent replacements for the PAR series of lighting devices currently available, but not limited to only those current designs. Equivalency referring in part to similar size, shape, at least as much lumen output, at least as electrically efficient, providing the same output angles, fitting the same sockets, and using the same power systems currently used in residential and commercial places.

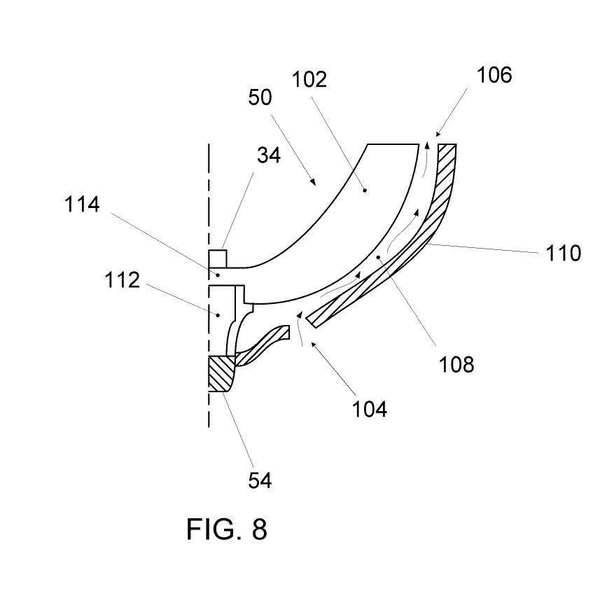

FIG. 8 illustrates a partial cross-sectional view of a solid-state lamp having an air channel 108 being partially formed between an external shell 110 and a heat fin 102, which in this embodiment is a protrusion from housing 50. The air channel shown in this embodiment is shown to have a first aperture 104 and a second aperture 106 wherein an air flow may be created when heat transfers from the outer portion of heat fin 102 and causes the surrounding air to be heated. The heated air then rises creating a lower pressure in the portion of the air channel near aperture 104. This lower pressure creates a draft, draught or natural flow of air as the higher pressure air just outside the air channel near first aperture 104 is drawn in. This flow of air in turn continues to assist in transferring heat from the heat fin and outer portion of housing 50 to the surrounding ambient environment. This is also referred to as a chimney effect to those skilled in the art.

One of the advantages of having an external shell 110 is that it is able to maintain a lower temperature than the outer housing 50 or protruding heat fin 102. One concern with filament-based lamps is the amount of heat these lamps produce, which in turn creates a very hot package or outer housing that in many instances may cause burns to human skin if held too long while in use or just after the lamp has been turned off. The external shell in this embodiment may be maintained at temperatures wherein human hands can handle the lamp either while in use and/or immediately after the lamp has been turned off. Also as a result, the heat fin 102 and housing 50 may be designed to dissipate even higher amounts of heat without a concern for causing either bodily damage or heat damage to immediately surrounding objects. In several embodiments the external shell is designed to maintain a temperature of less than 65° Celsius, while allowing for up to 10 watts of heat to be dissipated from the solid-state lamp. This calculation is based on a horizontal usage of the lamp where the chimney effect is still present, but not as effective as when the lamp is oriented vertically e.g. the light emitting surface in a PAR design is pointed to the ceiling or to the ground.

The external shell 110 may be made of metal or plastic. Though it is not shown in FIG. 8, the external shall may be attached to the housing 50 and/or heat fin 102 with an interior wall, thus creating a multiplicity of chimneys revolving around the outer portion of the solid-state lamp. The materials used as well as any coatings placed on the external shell as well as the housing and heat fins may be designed for high emissivity in the infra-red (IR) spectrum.

In some instances, the solid-state lamp as shown in FIG. 8 may be positioned upside down and therefore air would be drawn in through the second aperture 106 and exit through the first aperture 104 making this lamp omni-positionable.

Also shown in FIG. 8 is LED 34 mounted on top of heat sink 114, which is a part of housing 50 and directs heat through to heat fin 112 where it is transfer into the air channel 108. In some instances as described in previous embodiments, LED 34 may be mounted to a separate pedestal acting as a heat sink that in turn channels heat through to the housing or other heat fins, where it is dissipated. A cavity 112 is shown in the lower or base portion of the lamp design directly above the Edison-style connector 54, where at least a portion of an electronic driver may be located. As mentioned above, the flexibility of a segmented driver allows for the more efficient placement along thermal channels for those portions of the driver that produce a lot of heat. For example in FIG. 8 it may be more advantageous to place the secondary portion of the driver as described above closer to the heat sink 114 and the primary portion closer to the Edison-style connector 54.

Heat may also be dissipated into the ambient air directly above LED 34 inside the cavity portion formed by the housing. In this instance it has been contemplated of creating another chimney effect by placing at least one hole entering into the cavity portion near the mounted LED and having at least another hole towards the open portion of the housing where the emitted light exits the lamp. However, this might not be ideal for all embodiments as it may be desirous to seal off the system.

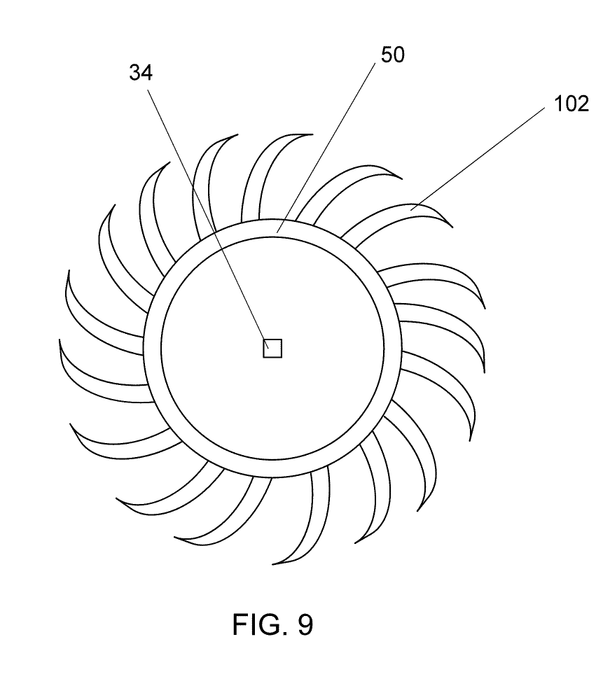

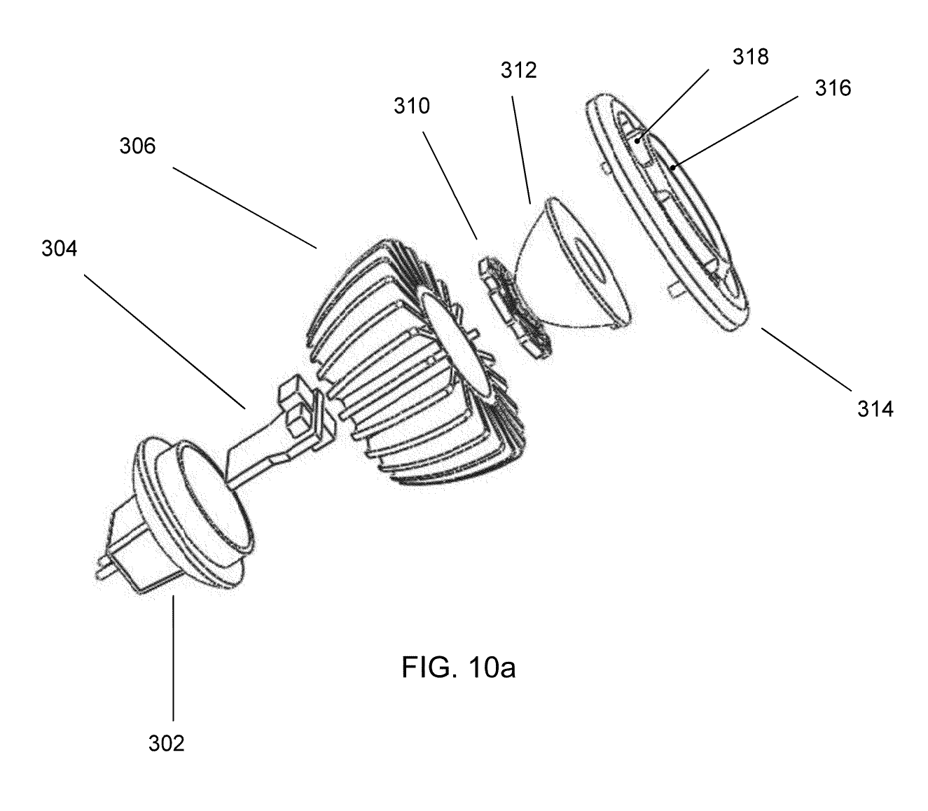

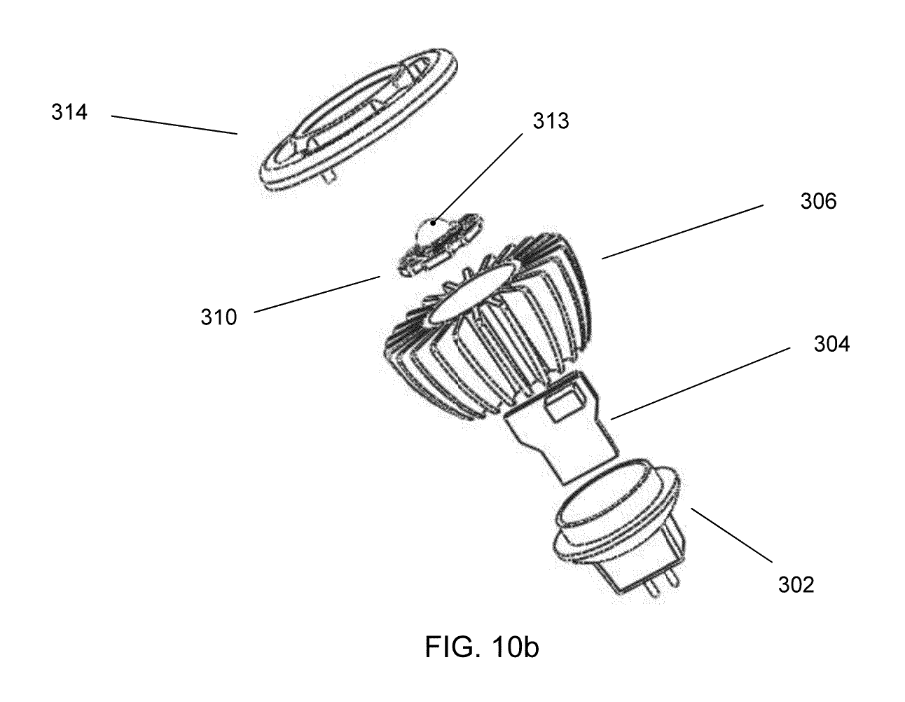

FIG. 9 is an illustrative top view of a lamp housing 50 having a multiplicity of heat fins 102 having an arching profile protruding away from the main portion of housing 50. An LED 34 is placed in the center and bottom portion of housing where a large amount of the heat is produced. It is contemplated that a number of heat fin designs such as the one illustrative in FIG. 9 are adequate to assist in the distribution of heat away from the solid-state lamp. As stated above, the housing and heat fins may be comprised of a number of highly heat conductive materials such as aluminum and in some instances coated that further enhances heat dissipation. These coatings take the forms of resins, lubricants and so forth and are known in the art.

FIGS. 10a-b illustrate exploded views of embodiments of an MR-16 replacement solid-state lamp device. As illustrated, the lamps in FIGS. 10a-b are comprised of a base 302 having a two-pin connector, which is standard for traditional-filament based MR lamps. The MR is an acronym for “multifaceted reflector” and is a known standard in the industry. Shown exploded from the base is a portion of a driver device 304 that as described above may be comprised of standard PCB core having components on two sides. The housing 306 is shown with heat fins is mounted on top of base 302. A thermal heat sink 310 mounts inside of and at the lower portion of housing 306. The thermal heat sink 310 may act as a mount for an LED (not labeled) and/or a secondary portion of a driver device as described above. In some embodiments, the driver device may be fully contained on a single board positioned in the base of the lamp.

FIG. 10a shows an additional TIR or total internal reflective optic that is contained within housing 306. For some embodiments using this type of optic the inner surface of housing 306 may not need to be polished as light emitted from an LED is reflected of the side walls until it passes through the top emission surface. FIG. 10b shows in embodiment without a TIR optic. However, a distribution optic 313 may be placed over an LED as shown in FIG. 10b to achieve the desired optical output angles in conjunction with the housing 306 and any additional optics or lenses that may be placed in an optic holder 314. Optic holder 314 as shown in the embodiments of FIG. 10a-b comprises a mountable edge 316 for holding a lens such as a micro lens array or other focusing optic as well as slotted air vents that aid in the heat distribution process. As described above, these slots help draw air around the heat fins. Optical holder 314 is mounted on top housing 306. It is also contemplated that in other embodiments a shroud may be attached to the optical holder 316, housing 3106 or even base 302.

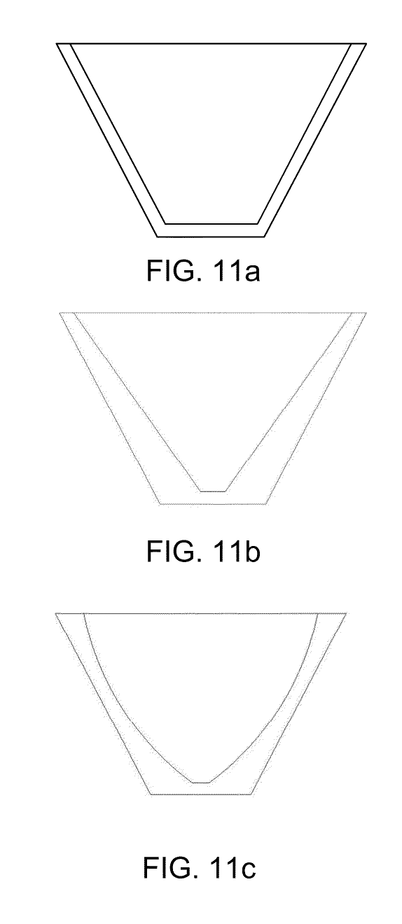

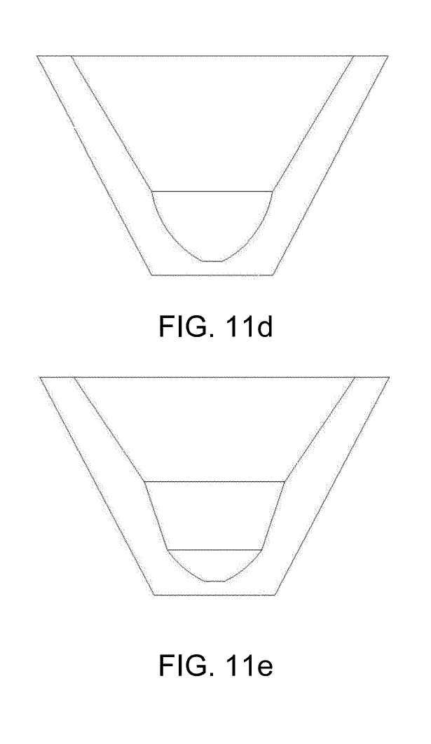

FIGS. 11a-e are illustrative of cross-sectional views of the internal designs used in various solid-state lamp embodiments described herein. The internal shapes of the housing are a part of an optical system that allow for a particular distribution. Present in the lighting industry are various standards for lamps emitting light at particular angles, with particular light intensities or candelas across those angles. The designs in FIGS. 11a-e are illustrative of some of the designs contemplated to achieve the particularized light output specifications. For instance, an embodiment shown in FIG. 11a has a tapered shape extending down into a wider flat region, while FIG. 11b has a broader angle taper with a shorter flat base. FIG. 11c shows a housing having a parabolic shape. FIGS. 11d-e are segmented designs combining parabolic curved portions with one or more angled portions.

Using FIG. 11a, as example, it is conceived that the dimensions (71 mm tall, 55.35 mm radius) would deliver the right optical distribution of light for a PAR 38 design. The generic shape (taper) reduces the angular distribution and can yield a uniform Gaussian distribution in the far field. Changing the angle of the wall will yield different angular distributions as shown in FIGS. 11b-e.

As mentioned, an optical element at the emission portion of a lamp (as shown in FIGS. 10a-b) can provide additional beam shaping. A lenslet array (an array of small lenses where each lens could be on the order of 1-10 mm in diameter and totaling in up to thousands of lenses) could serve to further modify the beam shape or it could serve to modify the beam homogeneity in both the near field (spatial intensity distribution) and far field (angular intensity distribution).

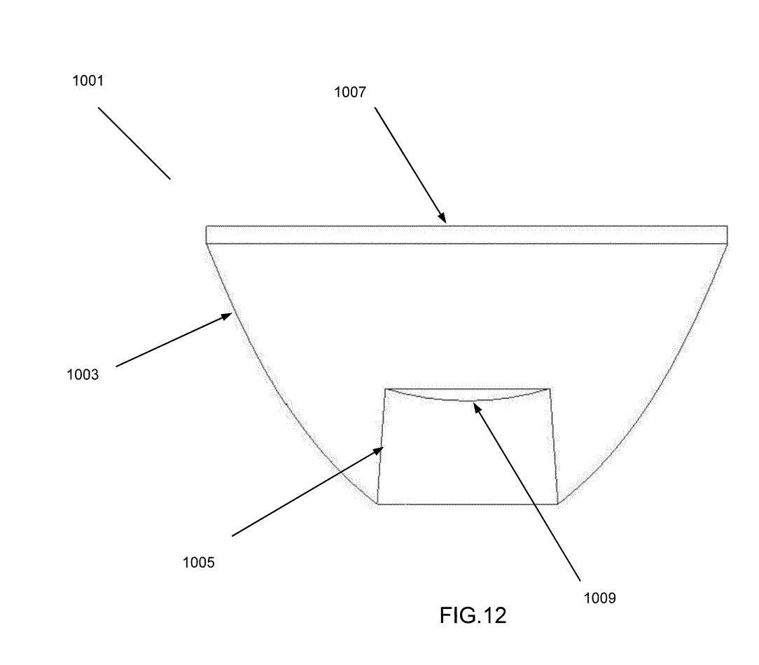

Secondary optics as 312 and 313 shown in FIGS. 10a and 1001 in FIG. 12 may also contribute to achieving a desired optical output. Such secondary optics usually includes several surfaces that can modify the beam shape, appearance, or performance of the lamp device. For instance, in secondary optic 1001 the outer surface 1003, which is typically a parabolic shape, can be tapered, have facets, or exhibit other shapes (ellipse, off-axis parabola, etc.) to manipulate light at its surface. Inner side-wall 1005 is typically a flat wall, but may also be turned into a beam shaping lens. Inner lens 1009 can be a flat, focusing, lensed, diffuser, or lenslet array surface as well as output surface 1007, which can also be a flat, lensed, focusing, diffuser, or a lenslet array surface.

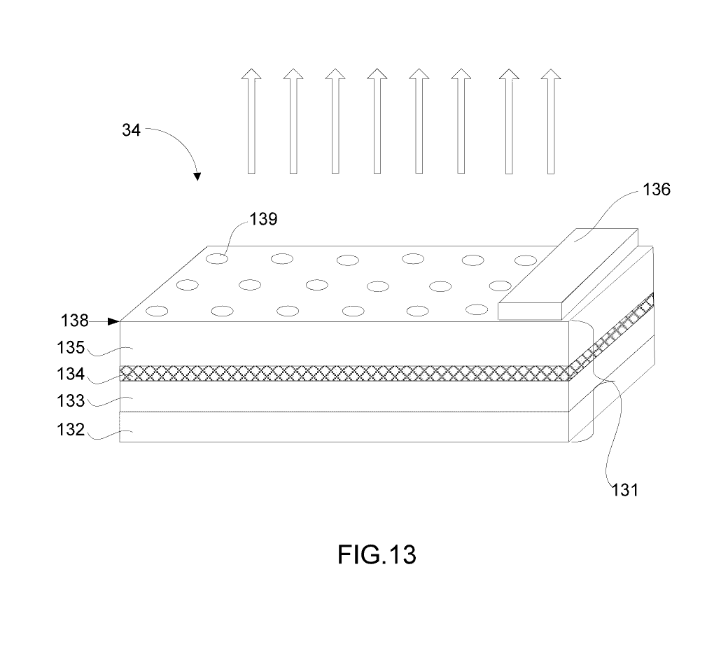

FIG. 13 illustrates an LED die that may be the light-generating component of a solid-state lamp, in accordance with one embodiment. It should also be understood that various embodiments presented herein can also be applied to other light-emitting devices, such as laser diodes, and LEDs having different structures. The LED 34 shown in FIG. 11 comprises a multi-layer stack 131 as shown in FIG. 1. The multi-layer stack 131 can include an active region 134 which is formed between n-doped layer(s) 135 and p-doped layer (s) 133. The stack can also include an electrically conductive layer 132 which may serve as a p-side contact, which can also serve as an optically reflective layer. An n-side contact pad 136 is disposed on layer 135. It should be appreciated that the LED is not limited to the configuration shown in FIG. 7, for example, the n-doped and p-doped sides may be interchanged so as to form a LED having a p-doped region in contact with the contact pad 136 and an n-doped region in contact with layer 132. As described further below, electrical potential may be applied to the contact pads which can result in light generation within active region 134 and emission of at least some of the light generated through an emission surface 138. As described further below, openings 139 may be defined in a light-emitting interface (e.g., emission surface 138) to form a pattern that can influence light emission characteristics, such as light extraction and/or light collimation. It should be understood that other modifications can be made to the representative LED structure presented, and that embodiments are not limited in this respect.

The active region of an LED can include one or more quantum wells surrounded by barrier layers. The quantum well structure may be defined by a semiconductor material layer (e.g., in a single quantum well), or more than one semiconductor material layers (e.g., in multiple quantum wells), with a smaller electronic band gap as compared to the barrier layers. Suitable semiconductor material layers for the quantum well structures can include InGaN, AlGaN, GaN and combinations of these layers (e.g., alternating InGaN/GaN layers, where a GaN layer serves as a barrier layer). In general, LEDs can include an active region comprising one or more semiconductors materials, including III-V semiconductors (e.g., GaAs, AlGaAs, AlGaP, GaP, GaAsP, InGaAs, InAs, InP, GaN, InGaN, InGaAlP, AlGaN, as well as combinations and alloys thereof), II-VI semiconductors (e.g., ZnSe, CdSe, ZnCdSe, ZnTe, ZnTeSe, ZnS, ZnSSe, as well as combinations and alloys thereof), and/or other semiconductors. Other light-emitting materials are possible such as quantum dots or organic light-emission layers.

The n-doped layer(s) 135 can include a silicon-doped GaN layer (e.g., having a thickness of about 4000 nm thick) and/or the p-doped layer(s) 133 include a magnesium-doped GaN layer (e.g., having a thickness of about 40 nm thick). The electrically conductive layer 132 may be a silver layer (e.g., having a thickness of about 100 nm), which may also serve as a reflective layer (e.g., that reflects upwards any downward propagating light generated by the active region 134). Furthermore, although not shown, other layers may also be included in the LED; for example, an AlGaN layer may be disposed between the active region 134 and the p-doped layer(s) 133. It should be understood that compositions other than those described herein may also be suitable for the layers of the LED.

As a result of openings 139, the LED can have a dielectric function that varies spatially according to a pattern which can influence the extraction efficiency and/or collimation of light emitted by the LED. In the illustrative LED 34, the pattern is formed of openings, but it should be appreciated that the variation of the dielectric function at an interface need not necessarily result from openings. Any suitable way of producing a variation in dielectric function according to a pattern may be used. For example, the pattern may be formed by varying the composition of layer 135 and/or emission surface 138. The pattern may be periodic (e.g., having a simple repeat cell, or having a complex repeat super-cell), periodic with de-tuning, or non-periodic. As referred to herein, a complex periodic pattern is a pattern that has more than one feature in each unit cell that repeats in a periodic fashion. Examples of complex periodic patterns include honeycomb patterns, honeycomb base patterns, (2×2) base patterns, ring patterns, and Archimedean patterns.

In some embodiments, a complex periodic pattern can have certain openings with one diameter and other openings with a smaller diameter. As referred to herein, a non-periodic pattern is a pattern that has no translational symmetry over a unit cell that has a length that is at least 50 times the peak wavelength of light generated by active region 134. Examples of non-periodic patterns include aperiodic patterns, quasi-crystalline patterns, Robinson patterns, and Amman patterns.

In certain embodiments, an interface of a light emitting device is patterned with openings which can form a photonic lattice. Suitable LEDs having a dielectric function that varies spatially (e.g., a photonic lattice) have been described in, for example, U.S. Pat. No. 6,831,302 B2, entitled “Light Emitting Devices with Improved Extraction Efficiency,” filed on Nov. 26, 2003, which is herein incorporated by reference in its entirety. A high extraction efficiency for an LED implies a high power of the emitted light and hence high brightness which may be desirable in various optical systems.

It should also be understood that other patterns are also possible, including a pattern that conforms to a transformation of a precursor pattern according to a mathematical function, including, but not limited to an angular displacement transformation. The pattern may also include a portion of a transformed pattern, including, but not limited to, a pattern that conforms to an angular displacement transformation. The pattern can also include regions having patterns that are related to each other by a rotation. A variety of such patterns are described in U.S. patent application Ser. No. 11/370,220, entitled “Patterned Devices and Related Methods,” filed on Mar. 7, 2006, which is herein incorporated by reference in its entirety.

Light may be generated by the LED as follows. The p-side contact layer can be held at a positive potential relative to the n-side contact pad, which causes electrical current to be injected into the LED. As the electrical current passes through the active region, electrons from n-doped layer(s) can combine in the active region with holes from p-doped layer(s), which can cause the active region to generate light. The active region can contain a multitude of point dipole radiation sources that generate light with a spectrum of wavelengths characteristic of the material from which the active region is formed. For InGaN/GaN quantum wells, the spectrum of wavelengths of light generated by the light-generating region can have a peak wavelength of about 445 nanometers (nm) and a full width at half maximum (FWHM) of about 30 nm, which is perceived by human eyes as blue light. The light emitted by the LED may be influenced by any patterned interface through which light passes, whereby the pattern can be arranged so as to influence light extraction and/or collimation.

In other embodiments, the active region can generate light having a peak wavelength corresponding to ultraviolet light (e.g., having a peak wavelength of about 370-390 nm), violet light (e.g., having a peak wavelength of about 390-430 nm), blue light (e.g., having a peak wavelength of about 430-480 nm), cyan light (e.g., having a peak wavelength of about 480-500 nm), green light (e.g., having a peak wavelength of about 500 to 550 nm), yellow-green (e.g., having a peak wavelength of about 550-575 nm), yellow light (e.g., having a peak wavelength of about 575-595 nm), amber light (e.g., having a peak wavelength of about 595-605 nm), orange light (e.g., having a peak wavelength of about 605-620 nm), red light (e.g., having a peak wavelength of about 620-700 nm), and/or infrared light (e.g., having a peak wavelength of about 700-1200 nm).

Additionally, white light may be produced having a variety of color temperatures in the range from 2500-6800 K. Color temperature of a light source is generally defined by the surface temperature of thermal radiation from an ideal black body radiator and is conventionally stated in units of absolute temperature, kelvin (K). Higher color temperatures, generally above 5,000 K, have more of a blue tint while lower color temperatures (2,700 K to 3,000K and also called warm colors) have more of a yellowish or red tint. The LED may also produce light as defined in the Energy Star program requirements for solid-state lighting luminaires version 1.1 including the seven step chromaticity quadrangles having nominal correlated color temperatures (CCT) of 2700K, 3000K, 3500K, 4000K, 4500K, 5000K, 5700K, 6500K wherein the corresponding CCTs are 2725+/−145, 3045+/−175, 3465+/−245, 3985+/−275, 4503+/−243, 5028+/−283, 5665+/−355, 6530+/−510.

The LEDs may also meet the requirements for variation of chromaticity having a color spatial uniformity within 0.004 from the weighted average point on the CIE 1976 diagram as defined on page 3 of the Energy Star program requirements for solid-state lighting luminaires version 1.1.

Another quantitative measure used in the lighting industry is the color rendering index (CRI). CRI is the ability of a light source to reproduce colors in the same manner as those produced by natural light and is based on a scale of 0-100. The closer to 100 the greater the ability to produce light that will show objects as close to the natural light or a specified reference illuminant. LEDs with a higher CRI number usually have a lower lumen output. This phenomenon occurs for a number of reasons including efficiency of LED materials used to produce the various colors and the eye's sensitivity to particular wavelengths.

The LEDs used in several of the described in embodiments have a CRI greater than 75, greater than 80, greater than 85, and in some instances greater than 90.

The LEDs used in some embodiments may have a lifetime of at least 25,000 hours and at least 35,000 hours wherein the lumen output is maintained at a level of 70% or greater than the initial lumen output of the retrofit lighting device. The LEDs may also exhibit a change of chromaticity over the lifetime (25,000 hours, 35,000 hours) less than or equal to 0.007 on the CIE 1976 diagram.

In certain embodiments, the LED may emit light having a high power. As previously described, the high power of emitted light may be a result of a pattern that influences the light extraction efficiency of the LED. For example, the light emitted by the LED may have a total power greater than 0.5 Watts (e.g., greater than 1 Watt, greater than 5 Watts, or greater than 10 Watts). In some embodiments, the light generated has a total power of less than 100 Watts, though this should not be construed as a limitation of all embodiments. The total power of the light emitted from an LED can be measured by using an integrating sphere equipped with spectrometer, for example a SLM12 from Sphere Optics Lab Systems. The desired power depends, in part, on the optical system that the LED is being utilized within. For example, a display system (e.g., a LCD system) may benefit from the incorporation of high brightness LEDs which can reduce the total number of LEDs that are used to illuminate the display system.

The light generated by the LED may also have a high total power flux. As used herein, the term “total power flux” refers to the total power divided by the emission area. In some embodiments, the total power flux is greater than 0.03 Watts/mm2, greater than 0.05 Watts/mm2, greater than 0.1 Watts/mm2, or greater than 0.2 Watts/mm2. However, it should be understood that the LEDs used in systems and methods presented herein are not limited to the above described power and power flux values.

Some embodiments include lighting devices having a lumen efficacy or lumens per watt (lm/W) greater than 20 lm/W. Additionally, as defined in the Energy Star program requirements for solid-state lighting luminaires version 1.1 some embodiments produce greater than 20 lm/W (e.g. greater than 24 lm/W, 29 lm/W, 30 lm/W, 35 lm/W, 40 lm/W and greater than 45 lm/W). Some embodiments have lumen outputs greater than 50 lumens output (e.g. 100, 150, 200, 300, and greater than 575 lumens output). Each of these embodiments also has a CRI, as described above, greater than 80 while having a lumen output greater than 575. In some embodiments, a single LED chip produces white light with a CRI of 85 or greater and a lumen output of greater than 600.

A lighting intensity benchmark tool has been provided by the government's ENERGY STAR program for achieving a particular candela output based on type, angle, size and current wattage equivalents for standard incandescent PAR and MR lamps. This tool can tool can be found at http://www.drintl.com/temp/ESIntLampCenterBeamTool.xls that was published on Jan. 16, 2009. The solid-state lamp embodiments using a single LED described herein are capable of achieving ENERGY STAR's candela output benchmarks described at the above sight for both incandescent PAR and MR lamps. For 75 Watt incandescent PAR lamps this results in a minimum center beam intensity of 6600 candelas (cd). The same single LED embodiments are capable of achieving the desired candela output for an MR design including producing a minimum center beam intensity of 10261 cd based on a 50 Watts incandescent MR having an output angle of 7 degrees.

Presently, the solid-state lamps described herein can achieve the same candela output and greater when consuming 5-20 Watts of power as compared to the 50 and 75 watt incandescent examples used above in addition to having a longer lifetime or lifespan as described above.

In some embodiments, the luminous flux of the lamp having a single LED is equal to at least 10 times the number of watts of the target incandescent lamp it is trying to replace. For example, the total luminous flux of a lamp having 60 watts would have a luminous flux of 600. Some embodiments, using a single LED at a cool white temperature, produce a total luminous flux up to 2,750 lumens.

In some embodiments, the LED may be associated with a wavelength-converting region (not shown). The wavelength-converting region may be, for example, a phosphor region. The wavelength-converting region can absorb light emitted by the light-generating region of the LED and emit light having a different wavelength than that absorbed. In this manner, LEDs can emit light of wavelength(s) (and, thus, color) that may not be readily obtainable from LEDs that do not include wavelength-converting regions.

Some of the single LEDs used in conjunction with various retrofit lighting devices include having surface emission areas larger than 1 mm², (e.g. larger than 3 mm², larger than 9 mm²) In some instances, the radiation emitted is uniform at all angles or Lambertian. The larger surface emitting LEDs also allow for greater output of radiation or light allowing for at least the same and often greater lumen output than traditional filament based lighting devices.

In some embodiments 85% of total lumens are within 0°-60° zone that is bilaterally symmetrical, 85% of total lumens are within 0°-90° zone that is bilaterally symmetrical, and others 35% of total lumens are within 120°-150° zone that is bilaterally symmetrical.

When a structure (e.g., layer, region) is referred to as being “on”, “over” “overlying” or “supported by” another structure, it can be directly on the structure, or an intervening structure (e.g., layer, region) also may be present. A structure that is “directly on” or “in contact with” another structure means that no intervening structure is present. The above description is merely illustrative. Having thus described several aspects of at least one embodiment of this invention including the preferred embodiments, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A solid-state lamp comprising:
a base having a first and second electrical terminal;
a driver device at least partially disposed in the base;
an LED electrically connected to the driver device;
a housing mounted to the base, wherein the housing is in thermal communication with the LED and a portion of the driver device.

2. The solid-state lamp of claim 1, wherein the driver device is comprised of a first portion and a second portion.

3. The solid-state lamp of claim 2, wherein the first portion of the driver device is thermally isolated from the second portion of the driver device.

4. The solid-state lamp of claim 2, wherein the first portion of the driver device is electrically isolated from the second portion of the driver device.

5. The solid-state lamp of claim 1, wherein the driver device further includes a flexible board.

6. The solid-state lamp of claim 2, wherein the second portion of the driver device is disposed at least partially around the LED.

7. The solid-state lamp of claim 2, wherein the LED is disposed on the second portion of the driver device.

8. The solid-state lamp of claim 2, wherein thermally isolative islands are disposed between the LED and the second portion of the driver device.

9. The solid-state lamp of claim 1, wherein the inner portion of the housing is partially reflective.

10. The solid-state lamp of claim 1, wherein the housing is configured to dissipate heat.

11. The solid-state lamp of claim 1, further including a shroud partially disposed over the housing, wherein an air channel is formed therein.

12. The solid-state lamp of claim 11, wherein the shroud remains below 65° Celsius during operation.

13. The solid-state lamp of claim 1, wherein a portion of the base is configured to fit into an Edison socket.

14. The solid-state lamp of claim 1, wherein the LED has an emission surface area greater than 1 mm2.

15. The solid-state lamp of claim 1, wherein the LED outputs white light having a color temperature between 2700K and 6500K.

16. The solid-state lamp of claim 1, wherein the CRI is greater than 80.

17. The solid-state lamp of claim 1, wherein the electricity to light output efficacy is greater than 82%.

18. The solid-state lamp of claim 1, wherein the lumen efficacy is equal to or greater than 45 lm/W.

19. The solid-state lamp of claim 1, wherein the lumen output is greater than 400 lumens.

20. The solid-state lamp of claim 1, wherein the housing forms an outer edge on distal end of the lamp and the base forms an outer edge on the proximal end of the lamp, and wherein the LED is positioned in a manner such that it is closer to the proximal end of the lamp.

21. The solid-state lamp of claim 1, further including a primary optic attached to the housing and secondary optic disposed entirely within the housing.

22. The solid-state lamp of claim 1, wherein the LED is a vertical chip design.

23. A solid-state lamp comprising:
a base having a first and second electrical terminal;
a driver device having a first portion partially disposed in the base and a second portion, wherein the second portion produces a higher current than the first portion;
an LED electrically connected to the driver device; and
a housing mounted to the base, wherein the housing is in thermal communication with the LED and the second portion of the driver device.

24. The solid-state lamp of claim 21, further including a shroud partially disposed over the housing, wherein an air channel is formed therein.

25. A solid-state lamp comprising:
a driver device having a first portion for receiving an alternating current, and a second portion thermally isolated from the first portion, wherein the second portion outputs more heat than the first portion;
an LED electrically connected to the driver device; and
a heat sink thermally connected to the second portion.
